(19) United States
(12) Patent Application Publication
(10) Pub. No.: US 2017/0354120 A1
(43) Pub. Date: Dec. 14, 2017

(54) OUTDOOR PET DRINKING APPARATUS

(71) Applicants: Tianle Yang, Zhongshan (CN); Yibao Zeng, Zhongshan (CN)

(72) Inventors: Tianle Yang, Zhongshan (CN); Yibao Zeng, Zhongshan (CN)

(21) Appl. No.: 15/190,217

(22) Filed: Jun. 23, 2016

(30) Foreign Application Priority Data
Jun. 8, 2016 (CN) 201620553214.6

(51) Int. Cl. A01K 7/00; B65D 51/18; B65D 51/24; A45F 3/20; B65D 39/00; B65D 47/14; B65D 1/02; B65D 41/02

(52) U.S. Cl. CPC A01K 7/00; B65D 1/02; B65D 51/18; B65D 41/02; A45F 3/20; B65D 39/0005; B65D 47/141; B65D 51/24; B65D 2251/0078; B65D 2251/0012; B65D 2251/0028; B65D 2251/009; B65D 2251/0087; B65D 2251/0025

(57) ABSTRACT

The disclosure relates to an outdoor pet drinking apparatus. The outdoor pet drinking apparatus comprises a bottle cap and a drinking bowl. A water outlet is provided at a top end of the bottle cap. The drinking bowl is fixed to the bottle cap. The drinking bowl is made of an elastic material. The drinking bowl is further provided with a cover or a bottle plug, which is connected to the drinking bowl and configured to cover the water outlet of the bottle cap. The drinking apparatus in the disclosure is convenient to carry outdoors so as to water or feed a pet, and the apparatus is simple to use, sanitary, and high in practicality.

### CROSS-REFERENCE TO RELATED APPLICATION

The present application claims the benefit of Chinese Utility Model Application No. 201620553214.6 filed on Jun. 8, 2016, the contents of which are hereby incorporated by reference.

### TECHNICAL FIELD

The disclosure relates to the technical field of animal supplies, and in particular to an outdoor pet drinking apparatus.

### BACKGROUND

As people's living standards rise, more and more pet-feeding families emerge in the modern society, and as the times progress, pet-feeding manners change accordingly. A traditional animal watering manner refers to placing a container, containing water or other liquids, at a specific position and allowing an animal to lick with its head down or to suck a water pipe communicated with a drinker. However, nowadays, pets not only stay at home, but also are taken to various occasions as friends of human beings. When going out to carry out outdoor activities, animals need to be supplied with food and clean drinking water, and therefore it is necessary to carry various containers, drinking bottles and the like. Obviously, it is quite inconvenient to feed and water pets outdoors. This problem needs to be solved urgently.

### SUMMARY

In view of this, the disclosure provides an outdoor pet drinking apparatus convenient to use outdoors, which aims at the above problem as necessary.

To this end, the technical solutions are adopted in the disclosure as follows.

An outdoor pet drinking apparatus in the disclosure may comprise a bottle cap and a drinking bowl. A water outlet may be provided at a top end of the bottle cap. The drinking bowl may be fixed to the bottle cap. The drinking bowl may be made of an elastic material. When it is unnecessary to use the drinking bowl, the drinking bowl may be folded to be attached to a bottle body into a whole. When it is necessary to use the drinking bowl, the drinking bowl may be turned away from the bottle body to form a bowl shape.

The drinking bowl may be further provided with a cover or a bottle plug, which is connected to the drinking bowl and configured to cover the water outlet of the bottle cap.

Furthermore, the bottle cap may comprise an upper bottle cap and a lower bottle cap, the upper bottle cap being provided over the lower bottle cap, and the lower bottle cap being larger than the upper bottle cap.

Furthermore, the upper bottle cap and the lower bottle cap may be formed integrally.

Furthermore, a groove may be provided on the bottle cap, the drinking bowl may be connected to a buckle ring via connecting portions, and the buckle ring may be buckled to the groove and fixed relatively.

Furthermore, the bottle cap and the drinking bowl may be formed integrally.

Furthermore, the elastic material may comprise flexible materials such as silicon rubber and a TPR material.

Furthermore, the cover or the bottle plug and the drinking bowl may be formed integrally.

Furthermore, the water outlet of the bottle cap may be a fillet or a notch.

Furthermore, the notch of the water outlet may be provided on a silicon rubber cap, and a plastic ring may be provided at the silicon rubber cap and configured to fix the silicon rubber cap.

Furthermore, seal rings may be provided inside the bottle cap.

Furthermore, an ear ring may be provided on the bottle cap.

The disclosure has beneficial effects as follows.

The bottle cap may be adaptive to two bottles having different diameters, and is high in generality; moreover, the bottle cap is formed integrally, installed simply and used conveniently; and the drinking bowl is foldable, after being folded, the drinking bowl forms a bowl shape and is configured to water or feed a pet, it is unnecessary to use an individual bowl during watering or feeding, a water bottle may be directly used, after being used, the drinking bowl is folded to be integrated with the bottle, thereby being convenient to use and carry.

### BRIEF DESCRIPTION OF THE DRAWINGS

FIG. 1 is an overall diagram of an outdoor pet drinking apparatus according to the disclosure;

FIG. 2 is a structural diagram of an uncapped outdoor pet drinking apparatus according to the disclosure;

FIG. 3 is a structural diagram of an outdoor pet drinking apparatus with a bottle cap and a drinking bowl combined according to the disclosure;

FIG. 4 is a structural diagram of an outdoor pet drinking apparatus with a drinking water bowl unfolded according to the disclosure;

FIG. 5 is an explosive diagram of an outdoor pet drinking apparatus according to the disclosure; and

FIG. 6 is an overall diagram of another solution for an outdoor pet drinking apparatus according to the disclosure.

Drawing marks: 1, bottle body; 2, bottle cap; 21, upper bottle cap; 22, lower bottle cap; 23, groove; 24, seal ring; 25, silicon rubber cap; 26, plastic ring; 27, ear ring; 3, drinking bowl; 31, cover; 32, connecting portion; 33, buckle ring; and 34, bottle plug.

### DETAILED DESCRIPTION

In order to make purposes, technical solutions and advantages of the disclosure clearer, the technical solutions of the disclosure will be further described clearly and completely together with the embodiments of the disclosure. It is important to note that the described embodiments are merely some of the embodiments of the disclosure, but not all of the embodiments. On the basis of the embodiments of the disclosure, all other embodiments obtained on the premise of no creative work of those skilled in the art fall within the protective scope of the disclosure.

### Embodiment 1

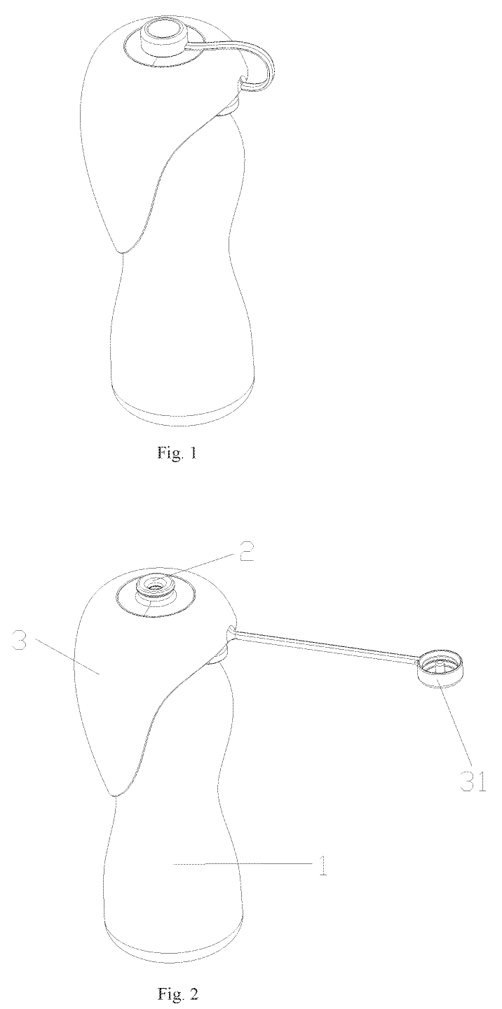

As shown in FIG. 1 and FIG. 2, an outdoor pet drinking apparatus in the disclosure comprises a bottle cap 2 and a drinking bowl 3. A water outlet is provided at a top end of the bottle cap 2. The drinking bowl 3 is fixed to the bottle cap 2.

The diameter of the bottle cap 2 is identical to that of a common bottle cap on the market, such that the bottle cap 2 is adaptive to a bottle on the market, and has strong generality. Threads are provided inside the bottle cap 2 and are configured to be rotationally connected to a bottle body 1, and a common beverage bottle on the market may be adopted as the bottle body 1.

The drinking bowl 3 is further provided with a cover 31, the cover 31 and the drinking bowl 3 are formed integrally, and the cover 31 is configured to cover the water outlet. The water outlet of the bottle cap 2 is a small fillet, and under the action of atmospheric pressure, water will not easily flow out after the cover 31 is closed; and after the cover 31 is opened, air pressure in the bottle is increased by squeezing a water bottle, and the water will automatically flow out.

As shown in FIG. 3, the bottle cap 2 comprises an upper bottle cap 21 and a lower bottle cap 22, the upper bottle cap 21 is provided over the lower bottle cap 22, and the lower bottle cap 22 is larger than the upper bottle cap 21, such that the bottle cap 2 may be adaptive to two bottle bodies 1 having different bottleneck sizes, and is strong in generality; the upper bottle cap 21 and the lower bottle cap 22 are formed integrally, thereby making it easier to install and convenient to use; and the bottleneck size of the upper bottle cap 21 is 27 or 30 mm, the bottleneck size of the lower bottle cap 22 is 38 mm, and the corresponding bottle body 1 has three types of common international general standard bottlenecks with the sizes of 27 mm, 30 mm and 38 mm.

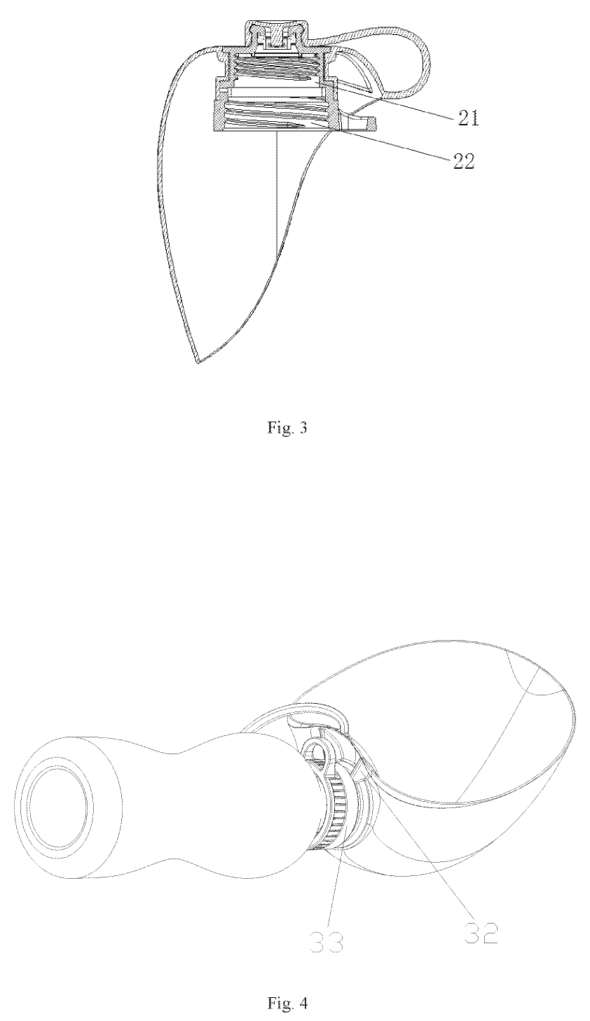

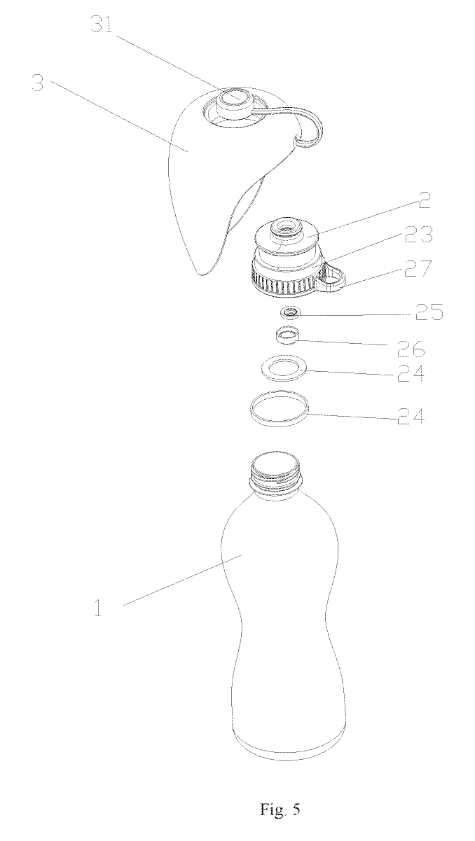

The drinking bowl 3 is made of an elastic material. When it is unnecessary to use the drinking bowl, the drinking bowl may be folded to be attached to the bottle body 1 into a whole. When it is necessary to use the drinking bowl, the drinking bowl is turned away from the bottle body 1 to form a bowl shape (as shown in FIG. 4). The elastic material of the drinking bowl 3 may be silicon rubber, TPR or other flexible rubber materials. By means of the characteristic of an elastomeric material, when it is necessary to use the drinking bowl, the drinking bowl is folded to form an included angle which is designed and obtained by means of an ergonomic principle according to posture angle habits of outdoor watering and feeding, and the drinking bowl 3 is turned away from the bottle body 1 to form a bowl body, so that an animal may be conveniently watered, and the apparatus is sanitary, simple and convenient to use, can be operated with one hand, and is applied to various occasions.

As shown in FIG. 4 and FIG. 5, one side of the drinking bowl 3 is high while the other side is low, and the lower side is connected to a buckle ring 33 via two rib-shaped connecting portions 32, such that when the drinking bowl 3 is folded, the lower side cannot be folded due to ribbed connection, and therefore a certain included angle can be formed; and the lower side of the drinking bowl 3 is made of a thick material while the higher side is made of a thin material, such that during folding, the lower side is difficult to fold due to the adoption of the thick material, a pulling effect is achieved, and the bowl body formed after folding can form a certain angle.

A groove 23 is provided on the lower bottle cap 22, the drinking bowl 3 is connected to the buckle ring 33 via the connecting portions 32, and the buckle ring 33 is buckled to the groove 23 and fixed relatively.

### Embodiment 2

As shown in FIG. 5, main differences between the embodiment 2 and the embodiment 1 are that the water outlet of the bottle cap 2 is a large outlet, a silicon rubber cap 25 is provided at the large water outlet, a notch is provided on the silicon rubber cap 25, a plastic ring 26 is provided at the silicon rubber cap 25, the plastic ring 26 is stuck at the water outlet and fixes the silicon rubber cap 25, due to a sealing action of the silicon rubber cap 25, water cannot flow out, when a water bottle is squeezed forcibly, air pressure in the bottle is increased, the notch is opened, and the water flows out.

When the water outlet in the disclosure is smaller, it is proper to water a pet, and when the water outlet is large, it may be proper to feed the pet with food.

### Embodiment 3

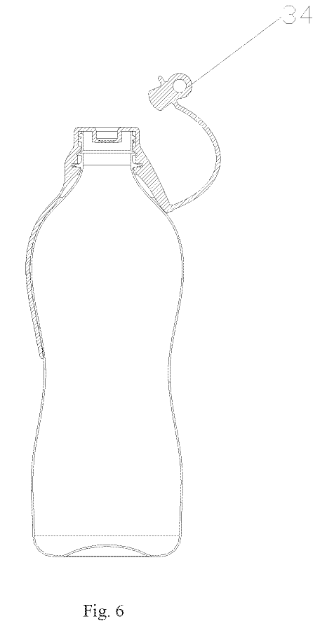

Main differences between the embodiment 3 and the embodiments 1 and 2 are that according to a specific bottleneck size of each bottle body 1, a bottle cap and a drinking bowl 3 are designed integrally by selecting flexible materials such as silicon rubber or TPR (as shown in FIG. 6), the bottle cap is not provided with threads, the bottle cap is provided with a water outlet, a notch is provided at the water outlet, and the bottle cap and the drinking bowl are put into the bottle body 1 of the same type integrally according to the characteristics such as the elasticity and sealing performance of the flexible materials such as silicon rubber or TPR; the drinking bowl 3 is further provided with a bottle plug 34, and the bottle plug 34 is connected to the notch at the water outlet; when it is unnecessary to use the drinking bowl, the drinking bowl is plugged with the bottle plug 34, and water will not flow out; when it is necessary to use the drinking bowl, the bottle plug 34 is pulled out, and the drinking bowl 3 is folded up to form a bowl shape; and after being used, the drinking bowl 3 is folded to be attached to the bottle body. In the embodiment, the structure is simpler, and parts are few.

In order to further enhance the sealing action, seal rings 24 are provided inside the bottle cap 2.

In order to facilitate hanging, an ear ring 27 is provided on the bottle cap 2.

The above embodiments only express several implementation modes of the disclosure, the descriptions thereof are relatively specific and detailed, but it cannot be accordingly interpreted as limits to the patent scope of the disclosure. It shall be pointed out that those skilled in the art can also make some modifications and improvements without departing from the concept of the disclosure. These modifications and improvements fall within the protective scope of the disclosure. As a result, the patent protection scope of the disclosure shall be subject to the appended claims.

What is claimed is:

1. An outdoor pet drinking apparatus, comprising a bottle cap and a drinking bowl, wherein a water outlet is provided at a top end of the bottle cap; the drinking bowl is fixed to the bottle cap; the drinking bowl is made of an elastic material; when it is unnecessary to use the drinking bowl, the drinking bowl may be folded to be attached to a bottle body into a whole, and when it is necessary to use the drinking bowl, the drinking bowl is turned away from the bottle body to form a bowl shape; and
the drinking bowl is further provided with a cover or a bottle plug, which is connected to the drinking bowl and configured to cover the water outlet of the bottle cap.

2. The outdoor pet drinking apparatus according to claim 1, wherein the bottle cap comprises an upper bottle cap and a lower bottle cap, the upper bottle cap is provided over the lower bottle cap, and the lower bottle cap is larger than the upper bottle cap.

3. The outdoor pet drinking apparatus according to claim 2, wherein the upper bottle cap and the lower bottle cap are formed integrally.

4. The outdoor pet drinking apparatus according to claim 1, wherein a groove is provided on the bottle cap, the drinking bowl is connected to a buckle ring via connecting portions, and the buckle ring is buckled to the groove and fixed relatively.

5. The outdoor pet drinking apparatus according to claim 1, wherein the bottle cap and the drinking bowl are formed integrally.

6. The outdoor pet drinking apparatus according to claim 1, wherein the elastic material comprises flexible materials such as silicon rubber and a TPR material.

7. The outdoor pet drinking apparatus according to claim 1, wherein the cover or the bottle plug and the drinking bowl are formed integrally.

8. The outdoor pet drinking apparatus according to claim 1, wherein the water outlet of the bottle cap is a fillet or a notch.

9. The outdoor pet drinking apparatus according to claim 7, wherein the notch of the water outlet is provided on a silicon rubber cap, and a plastic ring is provided at the silicon rubber cap and configured to fix the silicon rubber cap.

10. The outdoor pet drinking apparatus according to claim 1, wherein seal rings are provided inside the bottle cap, and an ear ring is provided on the bottle cap.
